(19) United States
(12) Patent Application Publication
(10) Pub. No.: US 2019/0275654 A1
(43) Pub. Date: Sep. 12, 2019

(54) Systems, Devices, and/or Methods for Hammers

(71) Applicant: Dennis McCormick, Chugiak, AK (US)

(72) Inventor: Dennis McCormick, Chugiak, AK (US)

(21) Appl. No.: 16/297,443

(22) Filed: Mar. 8, 2019

Related U.S. Application Data
(60) Provisional application No. 62/640,496, filed on Mar. 8, 2018.

(51) Int. Cl. B25D 1/02

(52) U.S. Cl. CPC B25D 1/02; B25D 2250/361; B25D 2250/065; B25D 2250/111

(57) ABSTRACT

Certain exemplary embodiments can provide a hammer. The hammer comprises a head. The hammer further comprises a head cap. The head cap is releasably coupled the head via a threaded fastener. The hammer comprises a claw. The claw comprises two forks. At least one of the two forks defines a serrated edge. The serrated edge is constructed to grip a slick surface when pulling a nail with the claw from the slick surface.

### CROSS-REFERENCES TO RELATED APPLICATIONS

This application claims priority to, and incorporates by reference herein in its entirety, pending U.S. Provisional Patent Application Ser. No. 62/640,496 (Attorney Docket No. 1271-03), filed Mar. 8, 2018.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a photograph 1000 of an exemplary embodiment of a hammer 1100;

FIG. 2 is a photograph 2000 of an exemplary embodiment of a hammer 2100; and

FIG. 3 is a photograph 3000 of an exemplary embodiment of a hammer 3100.

### DETAILED DESCRIPTION

Certain exemplary embodiments can provide a hammer. The hammer comprises a head. The hammer further comprises a head cap. The head cap is releasably coupled the head via a threaded fastener. The hammer comprises a claw. The claw comprises two forks. At least one of the two forks defines a serrated edge. The serrated edge is constructed to grip a slick surface when pulling a nail with the claw from the slick surface.

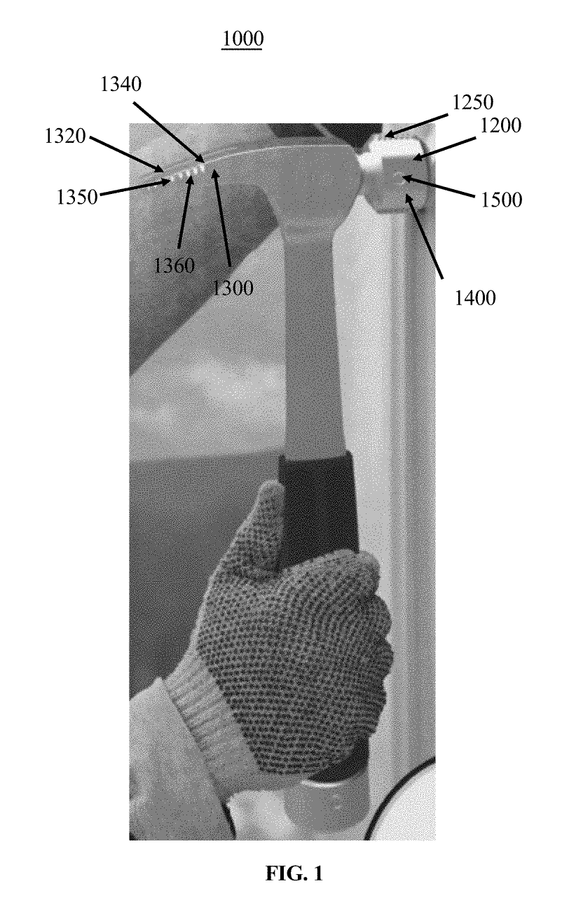

FIG. 1 is a photograph 1000 of an exemplary embodiment of a hammer 1100. Hammer 1100 defines a head 1200 and a claw 1300. Head 1200 defines a serrated surface 1250. Claw 1300 comprises a first fork 1320 and a second fork 1340. Claw 1300 defines one or more serrated edges 1350. In certain exemplary embodiments, claw 1300 can define a serrated edge of one or more serrated edges 1350 on second fork 1340 of claw 1300 as illustrated. In certain exemplary embodiments, claw 1300 can define a serrated edge of one or more serrated edges 1350 on first fork 1320 of claw 1300 (hidden in the view of photograph 1000. Via serrated surface 1250 and one or more serrated edges 1350, a user can have improved friction when using hammer 1100 to pull nails and/or other fasteners. Surfaces from which nails and/or other fasteners are to be pulled can be wet and/or icy. When surfaces from which nails and/or other fasteners are to be pulled are slick, hammer 1100 is more resistant to slippage because of serrated surface 1250 and one or more serrated edges 1350. Serrated surfaces provide additional friction when contacting opposing surfaces as compared to smooth surfaces. Accordingly, hammer 1100 can provide an improved ability to remove nails and/or other fasteners from systems comprising wet and/or icy surfaces.

Hammer 1100 comprises:
head 1200;
a head cap 1400, head cap 1400 releasably coupled head 1200 via a threaded fastener 1500; and
a claw 1300, the claw comprising two forks 1320 and 1340, at least one of two forks 1320 and 1340 defining a serrated edge 1360, wherein serrated edge 1360 is constructed to grip a slick surface when pulling a nail with claw 1300 from the slick surface.

In certain exemplary embodiments, head cap 1400 defines serrated surface 1250, wherein serrated surface 1250 of head cap 1400 is constructed to grip the slick surface when pulling the nail with claw 1300 from the slick surface.

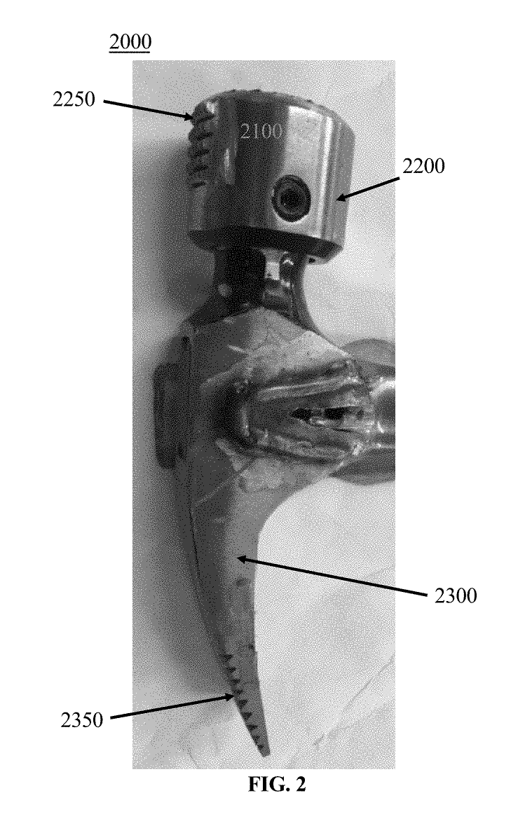

FIG. 2 is a photograph 2000 of an exemplary embodiment of a hammer 2100.

Hammer 2100 defines a head 2200 and a claw 2300. Head 2200 defines a serrated surface 2250. Claw 2300 defines one or more serrated edges 2350. Via serrated surface 2250 and one or more serrated edges 2350, a user can have improved friction when using hammer 2100 to pull nails and/or other fasteners such as from surfaces from which nails and/or other fasteners are to be pulled that are wet and/or icy. Hammer 1100 can provide an improved ability to remove nails and/or other fasteners from systems comprising wet and/or icy surfaces.

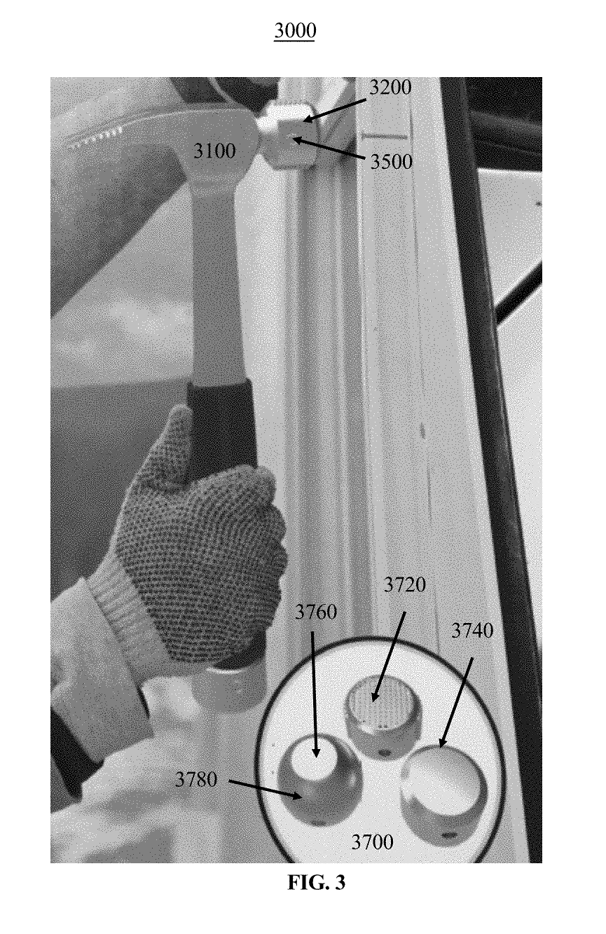

FIG. 3 is a photograph 3000 of an exemplary embodiment of a hammer 3100. Photograph 3000 illustrates a plurality of head caps 3700 coupleable to a head 3200 via a threaded fastener 3500. One of the plurality of head caps can comprise:
a serrated striking face 3720;
a striking face with a beveled edge 3740; and/or
a substantially planar striking face 3760 and has a partially spherical shape 3780.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapter—a device used to effect operative compatibility between different parts of one or more pieces of an apparatus or system.
and/or—either in conjunction with or in alternative to.
apparatus—an appliance or device for a particular purpose.
fork—one of two parts of a hammer claw.
associate—to join, connect together, and/or relate.
beveled—having an edge cut at an angle that is not a right angle.
can—is capable of, in at least some embodiments.
cap—an end covering for a hammer head that comprises the surface that contacts a surface impacted by the hammer head when the hammer is swung.
claw—a part of a hammer that comprises two forks and is used to pull nails from surfaces that have been penetrated by the nails. A claw comprises two forks that define a tapered gap in which nails are grasped for pulling.
comprising—including but not limited to.
configure—to make suitable or fit for a specific use or situation.
connect—to join or fasten together.
constructed to—made to and/or designed to.
coupleable—capable of being joined, connected, and/or linked together.
coupling—linking in some fashion.
define—to establish the outline, form, or structure of.
determine—to obtain, calculate, decide, deduce, and/or ascertain.
device—a machine, manufacture, and/or collection thereof.
edge—an outside limit of an object, area, or surface.
grip—to grab or resist sliding on a surface.
hammer—a tool comprising a weighted head coupled to a handle that is swung to deliver an impact to an area of an object.
head—a part of a hammer that delivers an impact to a surface contacted by the hammer head when the hammer is swung.
install—to connect or set in position and prepare for use.
may—is allowed and/or permitted to, in at least some embodiments.
method—a process, procedure, and/or collection of related activities for accomplishing something.
nail—a slender usually pointed and headed fastener designed to be pounded into a surface.
partially spherical shape—having a contour that at least in part is globular.
plurality—the state of being plural and/or more than one.
predetermined—established in advance.
provide—to furnish, supply, give, and/or make available.
pull—to exert force upon so as to remove (e.g., a nail from a surface).
receive—to get, take, acquire, and/or obtain.
releasably—coupled so as to be substantially nondestructibly removable.
repeatedly—again and again; repetitively.
serrated—notched or toothed on an edge.
slick—slippery.
store—to place, hold, and/or retain.
striking face—a surface of a hammer head or hammer head cap that contacts a surface struck when the hammer is swung.
substantially—to a great extent or degree.
support—to bear the weight of, especially from below.
surface—the outer boundary of an object or a material layer.
system—a collection of mechanisms, devices, machines, articles of manufacture, processes, data, and/or instructions, the collection designed to perform one or more specific functions.
threaded fastener—one (or more) restraints comprising projecting helical ribs via which parts can be screwed together, which restraints attach to, extend through, penetrate, and/or hold something and engage via. For example, a threaded fastener can be one (or more) of a bolt, a bolt and nut assembly and/or a screw, etc.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A hammer comprising:
a head;
a head cap, the head cap releasably coupled the head via a threaded fastener; and
a claw, the claw comprising two forks, at least one of the two forks defining a serrated edge, wherein the serrated edge is constructed to grip a slick surface when pulling a nail with the claw from the slick surface.

2. The hammer of claim 1, wherein:
the head cap defines a serrated surface, wherein the serrated surface of the head cap is constructed to grip the slick surface when pulling the nail with the claw from the slick surface.

3. The hammer of claim 1, further comprising:
a plurality of head caps coupleable to the head via the threaded fastener.

4. The hammer of claim 1, further comprising:
a plurality of head caps coupleable to the head via the threaded fastener, wherein one of the plurality of head caps comprises a serrated striking face.

5. The hammer of claim 1, further comprising:
a plurality of head caps coupleable to the head via the threaded fastener, wherein one of the plurality of head caps comprises a striking face with a beveled edge.

6. The hammer of claim 1, further comprising:
a plurality of head caps coupleable to the head via the threaded fastener, wherein one of the plurality of head caps comprises a substantially planar striking face and has a partially spherical shape.
